(19) United States
(12) Patent Application Publication
(10) Pub. No.: US 2004/0128801 A1
(43) Pub. Date: Jul. 8, 2004

(54) Method and apparatus for polishing elongated cylindrical articles

(76) Inventor: Jason Stickley, Calgary (CA)

Correspondence Address: STURM & FIX LLP, 206 SIXTH AVENUE, SUITE 1213, DES MOINES, IA, 50309-4076, US

(21) Appl. No.: 10/336,945

(22) Filed: Jan. 6, 2003

(51) Int. Cl. F16G 3/00

(52) U.S. Cl. 24/38

(57) ABSTRACT

A method and apparatus (10/100) for polishing elongated cylindrical articles (300) such as tubular railings or the like wherein a coupling connector (10) including gently curved inner (20) and outer (30) plate members are adapted to releasably yet captively engage the opposed ends (101) (101) of a length of belt material (100) wherein the normal orientation of the belt (100) is reversed so that the inner surface (105) has an abrasive texture and the belt (100) is disposed in an encircling relationship relative to the cylindrical article (300) so that a belt drive roller (201) attached to a grinder or drill (200) to rotate the abrasive texture of the inner surface (105) of the belt (100) to polish the periphery of the tubular/cylindrical article (300).

### BACKGROUND OF THE INVENTION

### CROSS REFERENCE TO RELATED APPLICATIONS

Not applicable.

1. Field of the Invention

The present invention relates to the field of endless belt constructions in general and in particular to a specific method of fabricating an endless belt for a particular task.

2. Description of Related Art

As can be seen by reference to the following U.S. Pat. Nos. 3,141,346; 4,331,453; 4,082,521; 4,258, 461, and 3,763,604, the prior art is replete with methods and apparatus employed to create an endless abrasive belt or the like.

While all of the aforementioned prior art constructions are more than adequate for the basic purpose and function for which they have been specifically designed, they are uniformly deficient with respect to their failure to provide a simple, efficient, and practical mechanical joint between the opposed ends of a length of belt material so that the abrasive surface faces inwardly on the endless belt so as to employ the endless belt to polish elongated cylindrical articles such as poles, railings, etc., in a quick and efficient manner.

Up until now the polishing of elongated cylindrical articles was a labor-intensive, time consuming task that had to be performed manually at regular intervals to maintain the desired appearance of the various elongated cylindrical articles.

As a consequence of the foregoing situation, there has existed a longstanding need among maintenance personnel assigned this task for a new and improved method and apparatus that, while not reducing the intervals between the periodic polishing, would significantly reduce the time and effort expended on that task, and the provision of such a method and apparatus is the stated objective of the present invention.

### BRIEF SUMMARY OF THE INVENTION

Briefly stated, the belt connector construction that is crucial to the method of this invention comprises an interior coupler unit and an exterior coupler unit adapted to captively engage a length of pre-cut and pre-punched abrasive belt material such that an endless looped belt is formed with the abrasive surface facing inwardly in a surrounding relationship relative to an elongated cylindrical article. Then belt is releasably engaged by a drill or grinder equipped with a belt device roller to rotate the abrasive surface against and around the periphery of the elongated tubular article to effect the polishing of the same.

As will be explained in greater detail further on in the specification, both the interior and exterior coupler units comprise gently curved plate members wherein the interior plate member has a smooth exterior surface and an interior surface provided with a plurality of threaded posts dimensioned to be received in the pre-punched holes on the opposed ends of the length of abrasive belt material.

In addition, both the interior and exterior faces of the exterior plate member are smooth and the opposed sides of the exterior plate member are provided with a plurality of recesses and apertures adapted to releasably and captively receive the threaded posts on this interior plate member wherein, a plurality of conventional fasteners are employed to bring the interior and exterior plate members together into tight frictional engagement with the opposed ends of the length of abrasive belt material the abrasive face of which is directed inwardly relative to the exterior surface of the endless loop belt.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view showing the method of polishing that can be practical in accordance with the teachings of this invention;

FIG. 2 is a perspective view of the interior and exterior plate units operatively joined together;

FIG. 3 is an exploded perspective view of the interior and exterior plate units;

FIG. 4 is a detail view of the polishing belt mounted on a belt roller drive of a drill or grinder in accordance with the teachings of this invention;

FIG. 5 is a perspective view of a prior art abrasive belt construction;

FIG. 6 is a perspective view of the finished belt construction that forms the basis of the present invention.

### DETAILED DESCRIPTION OF THE INVENTION

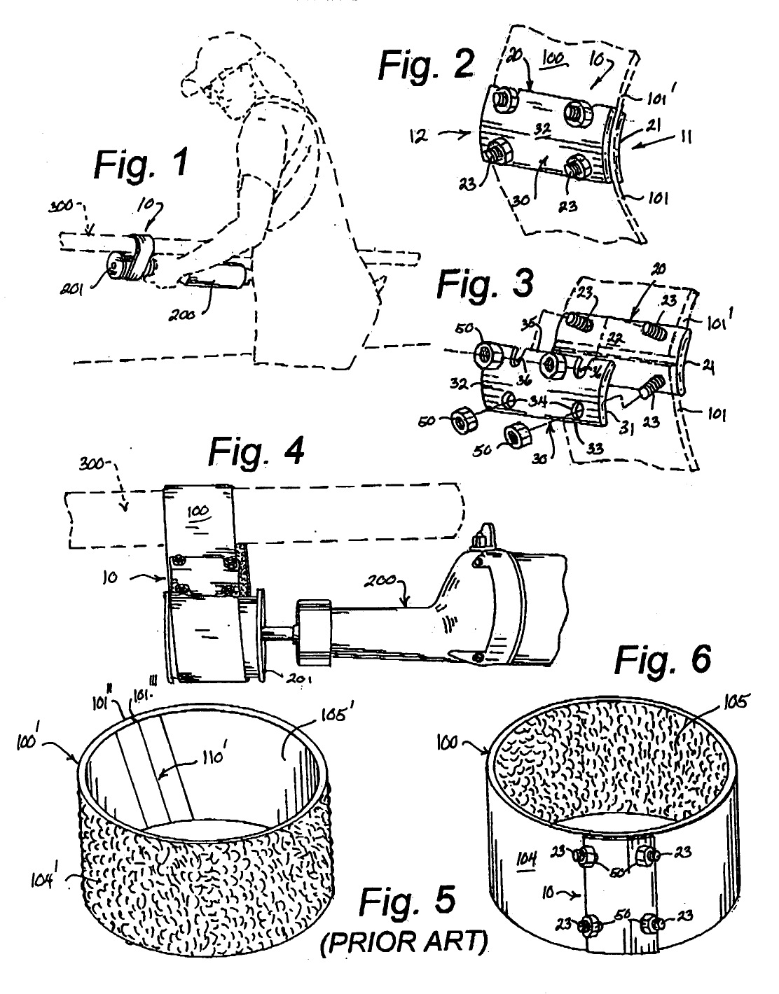

As can be seen by reference to the drawings, and in particular to FIGS. 1 through 3, the abrasive belt coupler construction that forms the basis of the present invention is designated generally by the reference number 10. The construction 10 comprises in general an inner coupler unit 11 and an outer coupler unit 12 joined together by a plurality of conventional fasteners 50 into captive engagement with a length of abrasive belt material 100 the opposite ends of which 101 101′ are provided with a plurality of pre-punched apertures the purpose and function of which will be described in greater detail further on in the specification.

As shown in FIGS. 2 and 3, the inner coupler unit 11 comprises a gently curved inner plate member 20 having a smooth inner surface 21 and an outer surface 22 provided with a plurality of outwardly projecting threaded posts 23 which are dimensioned to be received in the pre-punched apertures on the opposed ends 101 101′ of the belt material 100.

In addition, the outer coupler unit 12 likewise comprises a gently curved outer plate member 30 having generally smooth inner 31 and outer 32 surfaces wherein, one of the elongated sides 33 of the other plate member 30 is provided with a plurality of apertures 34 that are dimensioned to captivley receive selected ones of said plurality of threaded posts 23 on the inner plate member 20, and wherein, the other of the elongated sides 35 of the outer plate member 30 are provided with a plurality of recesses 36 that are dimensioned to laterally receive the remainder of the threaded posts 23 on the inner plate member 20.

At this juncture, a plurality of conventional fasteners 50 such as threaded nuts are operatively engaged with the threaded posts 23 to urge the inner 20 and outer 30 plate members toward one another to captivley engage the opposed ends 101 101′ of the length of abrasive belt material 100 in a well recognized fashion to produce the finished abrasive belt assembly depicted in FIG. 6 wherein, the outer surface 104 of the belt 100 is smooth and the inner surface 105 has an abrasive texture.

As shown in FIG. 5, a conventional finished abrasive belt 100′ has an outer surface 104′ provided with an abrasive texture and an inner surface 105′ that is generally smooth wherein, the belt coupler 110′ normally substantially engages the inner surface 104′ to join the opposed ends 101″ 101″ of the abrasive belt 100′ together with only minimal portions of the belt coupler 110′ being visible and/or projecting outwardly from the outer surface 105′ of the conventional abrasive belt 100′.

As was mentioned previously and as depicted in FIGS. 1, 4, and 5, the belt connector construction 10 of the present invention was specifically developed to create an abrasive belt forming an enlarged loop with the abrasive texture on the inner surface 105 of the belt 100 wherein, the releasable connector 10 allows the belt 100 to captively surround an elongated cylindrical article 300 such as a railing or the like.

Once the article 300 is captively encircled by the connector 10 and belt 100, a belt drive roller 201 mounted on a rotary drill or grinder 200 is engaged with the interior surface 105 of the belt 100 to rotate the abrasive textured inner surface 105 of the belt 100 around the periphery of the cylindrical article 300 to polish the cylindrical article 300 in significantly less time and with substantially less effort than required by manual polishing.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. An abrasive belt coupler construction for joining the opposite ends of a length of abrasive belt material together wherein, the coupler construction comprises:
an inner coupler unit including an inner plate member having an inner surface and an outer surface provided with a plurality of threaded posts disposed adjacent opposite sides of the inner plate member
an outer coupler unit including an outer plate member having an inner surface and an outer surface and a pair of opposite sides provided with means for receiving the plurality of threaded posts on the inner plate member; and,
a plurality of conventional fasteners for bringing the outer plate member and the inner plate member into captive engagement with the opposite ends of the length of abrasive belt material.

2. The coupler construction as in claim 1; wherein, said means for receiving the plurality of threaded posts includes at least in part: a pair of apertures dimensioned to receive at least two of said plurality of threaded posts.

3. The coupler construction as in claim 1; wherein, said means for receiving the plurality of threaded posts includes at least in part a pair of recesses dimensioned to slidably receive at least two of said plurality of threaded posts.

4. The coupler construction as in claim 1; wherein, said means for receiving the plurality of threaded posts comprises a pair of recesses for slidably receiving a first pair of threaded posts and a pair of apertures for receiving a second pair of threaded posts.

5. The coupler construction as in claim 4; wherein, said pair of recesses are disposed adjacent one of the opposite sides of the outer plate member.

6. The coupler construction as in claim 4; wherein, said pair of recesses are disposed adjacent the opposite sides of the outer plate member.

7. The coupler construction as in claim 5; wherein, said pair of apertures is disposed adjacent the other of the opposite sides of the outer plate member.

8. The coupler construction as in claim 6; wherein, said pair of apertures is disposed adjacent the opposite sides of the outer plate member.

9. A method of polishing an elongated cylindrical article with a length of abrasive belt material having an abrasive surface on one of its faces, a belt coupler construction and a grinder/drill provided with a drive belt roller comprising the steps of:
a) cutting the length of abrasive belt material to a length capable of forming a loop that will loosely encircle both the elongated cylindrical article and the belt roller drive on the grinder/drill;
b) forming a closed loop in accordance with step a) wherein, the abrasive face of the length of abrasive belt material is directed inwardly;
c) joining the opposed ends of the length of abrasive belt material together with the belt coupler construction;
d) bringing the drive belt roller into frictional engagement with the abrasive face of the length of abrasive belt material; and,
e) turning on the grinder/drill to rotate the abrasive face against the periphery of the elongated cylindrical article as the grinder/drill is rotated in a satellite fashion relative to the elongated cylindrical article.

10. The method as in claim 9 further comprising an intermediate step between step a) and step b) of
f) forming a plurality of apertures in the opposed ends of the cut length of abrasive belt material.

11. The method as in claim 10; wherein, the belt coupler construction comprises
an abrasive belt coupler construction for joining the opposite ends of a length of abrasive belt material together wherein, the coupler construction comprises:
an inner coupler unit including an inner plate member having an inner surface and an outer surface provided with a plurality of threaded posts disposed adjacent opposite sides of the inner plate member
an outer coupler unit including an outer plate member having an inner surface and an outer surface and a pair of opposite sides provided with means for receiving the plurality of threaded posts on the inner plate member; and,
a plurality of conventional fasteners for bringing the outer plate member and the inner plate member into captive engagement with the opposite ends of the length of abrasive belt material.

12. The method as in claim 11; wherein, said means for receiving the plurality of threaded posts includes at least in part: a pair of apertures dimensioned to receive at least two of said plurality of threaded posts.

13. The method as in claim 11; wherein, said means for receiving the plurality of threaded posts includes at least in part a pair of recesses dimensioned to slidably receive at least two of said plurality of threaded posts.

14. The method as in claim 11; wherein, said means for receiving the plurality of threaded posts comprises a pair of recesses for slidably receiving a first pair of threaded posts and a pair of apertures for receiving a second pair of threaded posts.

15. The method as in claim 14; wherein, said pair of recesses is disposed adjacent one of the opposite sides of the outer plate member.

16. The method as in claim 14; wherein, said pair of recesses is disposed adjacent the opposite sides of the outer plate member.

17. The method as in claim 15; wherein, said pair of apertures is disposed adjacent the other of the opposite sides of the outer plate member.

18. The method as in claim 16; wherein, said pair of apertures is disposed adjacent the opposite sides of the outer plate member.

19. The method as in claim 11; wherein, said plurality of apertures in the opposite ends of the length of abrasive belt material are dimensioned to receive said plurality of threaded posts on the inner plate member.
